(19) United States
(12) Patent Application Publication
(10) Pub. No.: US 2015/0356465 A1
(43) Pub. Date: Dec. 10, 2015

(54) VIRTUAL REALITY APPLICATIONS

(71) Applicants: Eric J. Levine, San Francisco, CA (US); Seth Glickman, San Francisco, CA (US)

(72) Inventors: Eric J. Levine, San Francisco, CA (US); Seth Glickman, San Francisco, CA (US)

(73) Assignee: GOOGLE INC., Mountain View, CA (US)

(21) Appl. No.: 13/403,758

(22) Filed: Feb. 23, 2012

(51) Int. Cl. G08B 5/22; G06T 19/00; H04W 4/00

(52) U.S. Cl. CPC G06Q 10/02; H04W 4/008; G06T 19/006

(57) ABSTRACT

This specification describes technologies relating to virtual reality applications. In general, one aspect of the subject matter described in this specification can be embodied in methods that include detecting, by circuitry included in a ticket carrier for carrying a public transportation system access ticket, an interaction between the ticket and an access point of the public transportation system at a first time point. The method also includes storing, on a storage device, a record of the interaction, and providing to a computing device, the stored record at a second time point different from the first time point. The executed operations of the computing device produce a virtual environment that partially represents the public transportation system and position a character within the virtual environment based upon the stored record. Other embodiments of this aspect include corresponding systems, apparatus, and computer program products.

### TECHNICAL FIELD

The present disclosure relates to systems and applications, such as games, that are based on virtual reality.

### BACKGROUND

Providers of some location based services allow users to register their locations. Location registering can be done automatically using the global positioning system (GPS) functionality of a suitably equipped mobile device. Alternatively, a user can also manually register their location over the internet.

### SUMMARY

In one aspect, the disclosure features a method that includes detecting, by circuitry included in a ticket carrier for carrying a public transportation system access ticket, an interaction between the ticket and an access point of the public transportation system at a first time point. The method also includes storing, on a storage device, a record of the interaction, and providing to a computing device, the stored record at a second time point different from the first time point. The executed operations of the computing device produce a virtual environment that partially represents the public transportation system and position a character within the virtual environment based upon the stored record.

In another aspect, the disclosure features a system that includes a ticket carrier configured to receive a public transportation system access ticket. The ticket carrier includes circuitry to detect and store an interaction between the ticket and an access point of the public transportation system at a first time point. The system also includes a computing device configured to receive a record of the interaction from the ticket carrier at a second time point different from the first time point. The executed operations of the computing device produce a virtual environment partially representing the public transportation system and position a character within the virtual environment based upon the record.

In another aspect, the disclosure features a computer readable storage device that has encoded thereon computer readable instructions. The instructions, when executed by a processor, cause the processor to perform operations that include receiving from a ticket carrier, a record of an interaction between a public transportation system access ticket and an access point of the public transportation system. The ticket carrier is configured to receive the ticket and detect and store the interaction. The operations also include creating a virtual environment that partially represents the public transportation system, and positioning a character within the virtual environment based on the received record. The operations further include receiving user-input representing an action of the character, and rendering the action of the character in the virtual environment based on the received instructions.

In another aspect, the disclosure features a method that includes detecting, by circuitry included in a ticket carrier associated with an access ticket to an entry-controlled system, an interaction between the ticket and an access point of the entry-controlled system at a first time point. The method also includes storing, on a storage device, a record of the interaction, and providing to a computing device, the stored record at a second time point different from the first time point. The executed operations of the computing device produce a virtual environment that partially represents a real environment within the entry-controlled system. The method further includes positioning, based on the record, a an object within the virtual environment.

In another aspect, the disclosure features an apparatus that includes an opening configured to receive a public transportation system access ticket and circuitry for detecting an interaction between the ticket and an access point of the public transportation system. The apparatus also includes a storage device configured to store a record of the interaction. The ticket carrier is capable of providing the stored record to a computing device. Executed operations in the computing device produce a virtual environment that partially represents the public transportation system and position a character within the virtual environment based upon the stored record.

Implementations can include one or more of the following.

Detecting the interaction can be based at least on a communication between the access point and a near-field communication (NFC) chip included in the circuitry. Detecting the interaction can be based at least on a communication between the access point and a radio frequency identification (RFID) tag included in the circuitry. The storage device can be provided on the ticket carrier. The virtual environment can include at least one other character positioned at another location based on another stored record that represents another detected interaction. Storing the record of the interaction can include storing data that represents a time and place of the interaction. Providing the stored record to the computing device can include providing the stored record to a mobile device from the ticket carrier.

The circuitry of the ticket carrier can include a near-field communication (NFC) chip. The circuitry in the ticket carrier can include a radio frequency identification (RFID) tag. The ticket carrier can further include a transmitter to transmit the record of the interaction. The computing device can be a mobile phone. The computing device can be configured to receive the record of the interaction from a mobile phone. The virtual environment can be rendered on a client device. The position and actions of the character within the virtual environment can be controlled using the client device.

The computer readable storage device can include instructions to receive the user-input from a client device. The computer readable instructions can be executed on the client device. The computer readable storage device can include instructions to position at least one other character within the virtual environment based on another received record that represents another interaction. The record of the interaction can be received from the ticket carrier through at least one intervening computing device.

The entry-controlled system can be a public transportation system. The public transportation system can be a highway system. The apparatus can include a transmitting device to transmit the stored record to the computing device. The circuitry in the apparatus can include a near-field communication (NFC) chip. The apparatus can further include a communication port to facilitate coupling of the apparatus to the computing device.

The invention provides numerous benefits and advantages (some of which may be achieved only in some of its various aspects and implementations) including the following. Virtual reality (VR) or augmented reality (AR) games and applications that represent a portion of a real world environment can be implemented while taking advantage of an existing network of radio-frequency identification (RFID) or near field communication (NFC) readers. Mundane activities such as daily commutes over a public transport system can be translated into exciting games and applications. For example, multi-person games and applications can be implemented based on virtual characters that correspond to various users. Using a separate ticket carrier (for carrying transportation access tickets) to detect and record interactions with access points of a system obviates the need to retrieve information from data sources maintained by a municipality or government agency. The ticket carriers can be personalized to reflect preferences of individual users.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example environment for using real world data in a virtual reality application.

FIG. 2 is a block diagram of an example system for implementing virtual reality applications.

FIG. 3 is a flowchart of an example of a sequence of operations for implementing a virtual reality application.

FIG. 4 is a block diagram of an example computer system.

Like reference numbers and designations in the various drawings indicate like elements.

### DETAILED DESCRIPTION

The present disclosure describes methods and systems for implementing a virtual reality or augmented reality application that uses location information of a user collected during user interactions with access points of a public transportation system (e.g., while swiping an access card or ticket across an electronic reader). The location information can be collected, for example, when the user enters or exits a public transportation system by using a card, ticket or pass (in general, a ticket) at different access points. Interactions with ticket scanners or card readers at the access points can be detected and stored using a suitably equipped ticket carrier such as a sleeve or another type of portable device that can be used to carry a ticket. The stored records can then be provided to a server at a later time and used to determine a position of a virtual character e.g., one representing the user within an application that is set against a virtual environment. The virtual environment at least partially represents the public transportation system. For example, the virtual reality application can be a multiplayer game set against a backdrop that represents a real world public transportation system in which virtual characters representing various users can compete or cooperate with one another to achieve game objectives. Along with allowing riders to temporarily escape from the daily monotony of transportation system use, the gaming aspect may actually increase system usage.

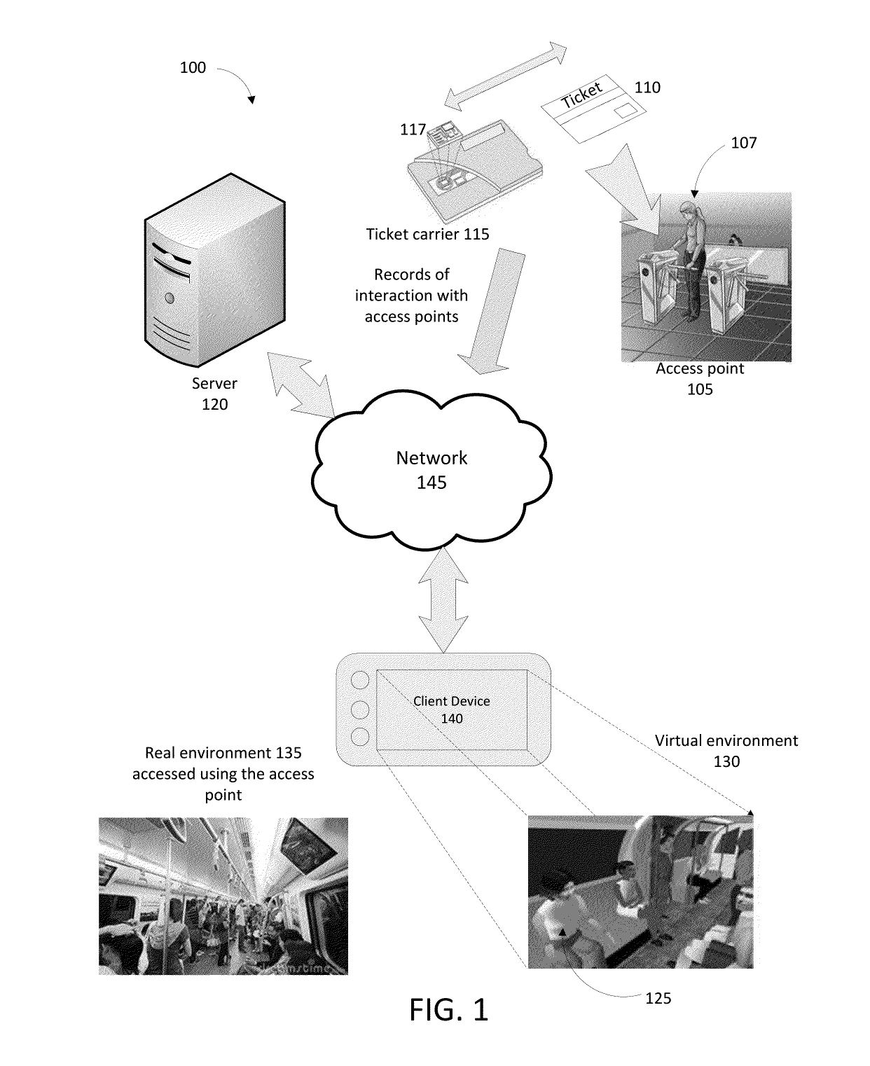

FIG. 1 is a block diagram of an example environment 100 for implementing virtual reality applications. In broad overview, the environment 100 includes a plurality of access points (illustrated with access point 105) that a user 107 can access using a ticket 110. In this arrangement, the user 107 carries the ticket 110 inserted within a ticket carrier 115 that includes circuitry 117 to detect and store interactions of the ticket 110 with the access point 105. The ticket carrier 115 can be further configured to provide (e.g., to a server 120) location information of the user 107 based on the stored interaction records. The location information can be used for determining the positioning of a virtual character 125 related to the user 107 within a virtual environment 130. In this example, the virtual environment 130 corresponds to a portion of the real environment 135 (e.g., the interior of a subway car) that the user 107 is granted access by passing through the access point 105. The virtual environment 130 may be created by an application that is executed by the server 120 and rendered on a computing device such as a mobile device (e.g., a smart phone, tablet computing device, etc.). In some implementations, the application that creates the virtual environment can also be executed by another computing device (e.g.: a mobile device) in communication with the server 120. To facilitate communications in this example, a network 145 (e.g., the Internet) provides for information exchanging among the ticket carrier 115, the server 120 and other computing devices (e.g., for displaying the virtual environment).

In some implementations, the access point 105 is an entry or exit point to a public transportation system. For example, the access point 105 can be an entry/exit point to a subway, train station, bus station, or airport. In some implementations, the public transport system can be a highway system and the access point 105 can be a toll booth or other entryways to enter the highway system. The access point 105 may also be a facility that allows renting or borrowing other means of transportation such as a bicycle, motorcycle, car, or other personal transport devices. In general, the access point 105 is equipped with a reader device that is configured to read or scan tickets or passes to determine whether access can be granted. In some implementations, the access point 105 is equipped with a near-field communication (NFC) reader that reads or scans tickets using short range wireless technologies. The access point can also be equipped with a radio frequency identification (RFID) reader that scans tickets by using one or more radio frequency communication techniques. In some implementations, the access point 105 can also be equipped with another form of identification device that uses one or more of the following technologies: biometric identification, bar code identification, optical character recognition, voice recognition, magnetic stripes or another automatic data capture technology, to name a few.

The access point 105 can be a gate that includes, for example, a turnstile, sliding doors, barriers or swinging arms. In some implementations, the access point 105 can be a card reader positioned near the door of a tram or bus. In general, the reader device at the access point 105 allows for data exchange with the ticket 110. For example, if the access point 105 includes a NFC reader, one or more NFC chips on the ticket 110 can send encrypted data a short distance to the reader located at the access point 105. The NFC chip on the ticket 110 may be queried or energized by the reader at the access point 105 to transmit data to the reader when the ticket 110 is brought within an appropriate range to the reader. In some implementations, where the reader at the access point 105 is an RFID reader, the ticket 110 can include an RFID tag that is read by the reader.

The ticket 110, in general, can be considered an object that can be detected at the access point 105 to determine whether a user carrying the ticket 110 can be granted access through the access point. The ticket 110 can take different forms and provide one or more types of functionalities. For example, the ticket 110 can be a piece of paper or cardboard with a magnetic stripe, a smart card with an embedded chip, a token, or an RFID tag. In some implementations, a personal handheld device such as a mobile phone equipped with NFC capabilities (or another type of wireless information exchange technique) can be used as the ticket 110. The ticket 110 can be a pass (such as a monthly or annual pass) that allows access through access points 105 for a predetermined duration of time, or can be a pay-per-use ticket that can be used as long as there is a balance on the ticket. In general, the ticket 110 includes a storage mechanism or storage device that stores time, balance, or account information. The ticket 110 can also include circuitry (such as a NFC chip or an RFID tag) to interact with the readers on the access points 105.

In some implementations, the ticket 110 can be stored within a ticket carrier 115 (e.g., for carrying be an individual). The dimensions of the ticket carrier 115 are such that at least a portion of the ticket 110 is supported by the ticket carrier. For example, the ticket carrier 115 can include a recess in which the ticket 110 is inserted. In some implementations, the ticket carrier 115 can reside in proximity to the ticket 110 and still detect the interactions between the ticket and the readers at the access points 105. For example, if the ticket is an RFID tag used to access a highway system, the ticket carrier can be a separate RFID tag that, when placed in proximity to the ticket, can detect the interactions between the ticket and RFID readers. The term ticket carrier, as used in this application, generally refers to an object or device that can detect and/or store interactions between a ticket and a reader at an access point 105. It should be noted that in some implementations, the ticket may not physically reside within the ticket carrier 115.

In general, the ticket carrier 115 includes circuitry 117 that is configured to detect interactions between the ticket 110 and a reader at an access point (e.g., the access point 105). For example, if the ticket 110 and the reader at an access point 105 interact using NFC, the circuitry 117 can be configured to detect the NFC between the ticket 110 and the reader. The ticket carrier 115 can also include a storage device, for example, magnetic memory, that is configured to store records of the interactions between the ticket 110 and readers at access points 105. For example, if the user 107 attempt to be granted entry to the access point 105 using the ticket 110, the ticket carrier 115 can be configured to detect and store, as a record, the time of the interaction, location of the access point and possibly other types of information associated with the interaction.

The records stored on the ticket carrier 115 can be used to provide location information about the user carrying the ticket 110. For example, if the stored records indicate that a user entered a subway system at time T1 and access point A1, and exited the subway system at time T2 and access point A2, the location information could be that the user traveled between the stations housing the access points A1 and A2 using the subway in time (T2 minus T1). In some implementations, the exit points could be preprogrammed into the ticket 110. For example, if a ticket only allows travel between stations A and B, the location information about a user can be determined from a stored record that provides information about the interaction of the ticket with an access point at either station A or station B. In some implementations, the communication protocols and technologies used to detect the interactions between the ticket 110 and the reader and an access point 105 are selected such that they do not interfere with the interactions themselves.

In general, the records stored on the ticket carrier 115 can be provided to the server 120. In some implementations, the ticket carrier 115 can communicate with the server 120 through the use of one or more intermediate devices. For example, the ticket carrier 115 can be configured to communicate with a mobile device to transfer the records stored on the ticket carrier 115 to the mobile device. The mobile device can then transmit the records to the server 120. Communications between the ticket carrier 115 and a mobile device can be facilitated using short distance wireless communication technologies such as NFC, or Bluetooth, etc. or by using a wire to connect the ticket carrier 115 with the mobile device. In some implementations, the ticket carrier 115 can also be connected to a computing device such as a personal computer or laptop to transfer the records stored on the ticket carrier 115 to the server 120. In some implementations, the ticket carrier 115 can be configured to communicate with dedicated hardware devices, for example, and NFC kiosk, to transfer the records to the server 120. In some cases, the ticket carrier 115 can also include a transceiver capable of communicating directly with the server 120, for example over Wi-Fi or some other wireless data network.

The records of interactions with the access points 105 can be provided to the server 120 at a time chosen by the user of the ticket carrier. In some implementations the records stored on the ticket carrier 115 are provided to the server 120 at a time point that is different from the time points at which the corresponding interactions are detected. Further, the functionality of transferring the records or location information to the server 120 can be provided only on the user of the ticket carrier 115 authorizing such a transfer. The authorization can be provided, for example, by providing a password during transferring the records to the server 120. Such functionalities allow the user of the ticket carrier 115 to protect privacy of the records stored on the ticket carrier 115. In some implementations, security measures can be provided on the ticket carrier 115 to prevent theft, unauthorized retrieval, or manipulation of the records stored on the ticket carrier 115. Similar data protection and security measures can also be associated with the server 120.

The ticket carrier 115 can be provided to the users by a service provider that utilizes the location information stored in the ticket carrier. For example, if the location information from the records is used in a virtual reality game, the game provider can provide the ticket carrier 115 to users who sign up to participate in the game. In some implementations, each user has a unique virtual identity, such as a uniquely assigned virtual character (e.g., an avatar), and the ticket carrier 115 can be personalized with an image or other representation of the virtual character. When interactions between access points 105 and tickets 110 are independently detected and stored by the ticket carrier 115, the game provider can obtain location and/or time information about the user from the server 120 without having to access data resources maintained by the provider that operates the access points 105.

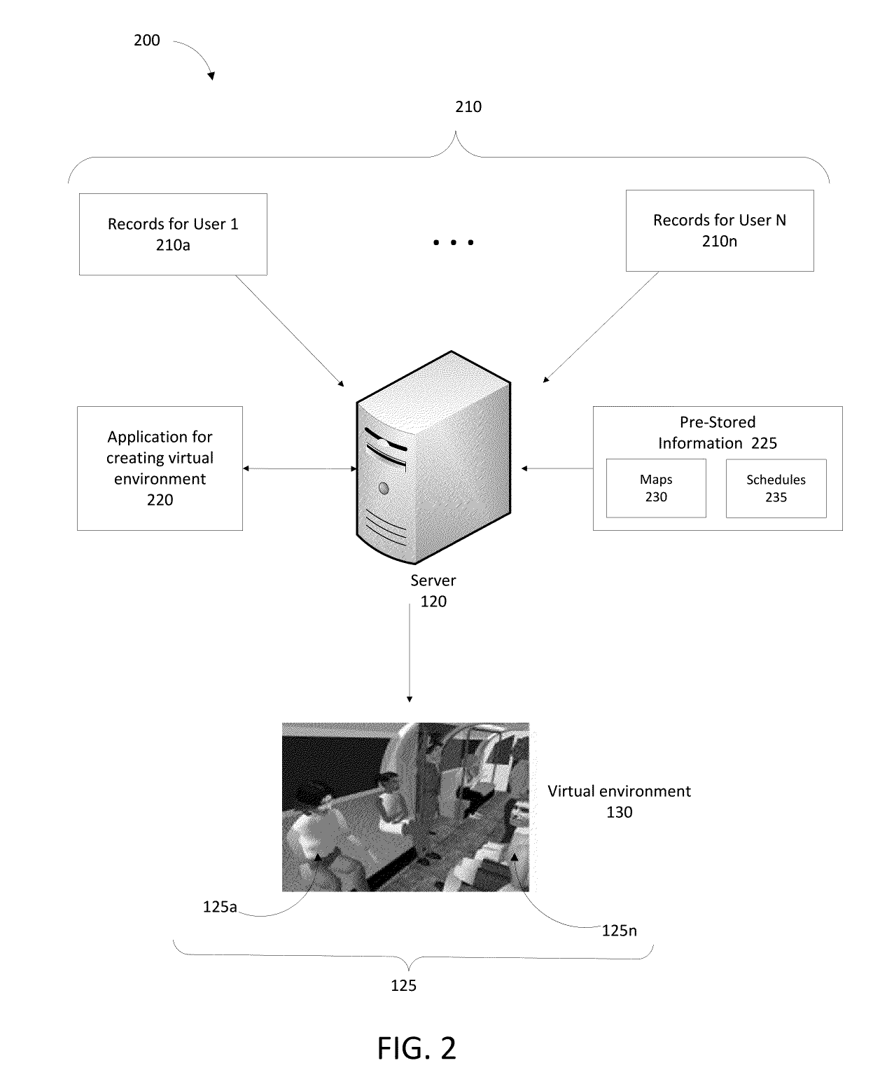

The location and/or time information about the user can then be used by the game provider to determine positioning of a corresponding virtual character in a virtual environment 130 that at least partially represents the real environment 135 corresponding to the location and/or time. For example, if the virtual reality game is played in a virtual environment that represents a subway system, the location and/or time information about the user can be used by the game provider to determine in which train, or with which other characters should a particular virtual character be placed. The location and/or time information can be used, for example, to translate real-life interactions into in-game actions. For example, if a user and three other friends (all of whom are registered with a game provider and have corresponding virtual characters) take a particular train at the same time, the four users can cooperate or compete to achieve game objectives in a virtual environment that at least partially represents the train that they took together. Integrating the records stored on ticket carriers for different users is described in detail with reference to FIG. 2.

The virtual environment 130 is created by executing an application. The application that creates the virtual environment 130 can execute on a computing device such as the server 120. In some implementations the server 120 executes the application and presents the virtual environment 130 on a client device 140. The client device can include, for example, computing devices such as mobile phones, desktop computers, laptop computers, handheld gaming devices or other personal devices. The client device 140 can be used by a user to interact with the application that creates the virtual environment 130. For example the application can be a virtual reality game and the client device 140 can be used for providing user input for the virtual reality game.

In some implementations, the application that creates the virtual environment 130 can also execute on the client device 140. In such cases, the client device communicates with the server 120 to retrieve related location information. In some implementations, the application that creates a virtual environment 130 can execute on a third computing device that communicates with the server 120 whereas the virtual environment 130 is rendered on the client device 140.

In some implementations, the virtual environment 130 can at least partially represent a real environment 135. In other implementations the virtual environment 130 can be generally unrelated to any real-world environment (e.g., a completely fanciful environment). For example, the location information retrieved from the server 120 can be used only to determine which groups of users can play a particular game together. In such cases, for users who have taken a train together, the location information can be used to position corresponding virtual characters together in a virtual environment that resembles a room rather than the real environment 135 of the train that they took together. In some cases, the virtual environment 130 can simply be a logical grouping of users such as a discussion forum or chat room. In some implementations, the location information can be used to group together users that have had the same or at least substantially similar experiences. For example, the location information retrieved from the server 120 can be used to group together people who take a particular train during a particular time of the day so that they can share with each other experiences such as delays, availability of seating or other topics of interest pertaining to that particular train.

Communication between two or more of the ticket carrier 115, the server 120 and the client device 140 can be facilitated by a network 145. The network 145 can include one or more different types of networks. For example, the network 145 can include a local area network (LAN), such as a company intranet or a home network. In some implementations, the network 145 can include a metropolitan area network (MAN) or a wide area network (WAN) such as the Internet. In other implementations, the network 145 can include a combination of one or more different types of network. For example, a LAN such as the home network may be connected to an external access network. In such cases, one or more gateway devices can act as interfaces between two different networks.

The network 145 can be of any type and form and may include any of the following: a point to point network, a broadcast network, a computer network, a power line network, an Asynchronous Transfer Mode (ATM) network, a Synchronous Optical Network (SONET), a Synchronous Digital Hierarchy (SDH) network, a wireless network and a wired network. If the network 145 is at least in part a wired network, the network 145 can include one or more of the following: coaxial cable, telephone wires, power line wires, twisted pair wires or any other form and type of wire. The topology of the network 145 can be a bus, star or a ring topology or any other topology capable of supporting the operations described herein. In some implementations, the network 145 can be separate from the network that includes the access points 105.

FIG. 2 is a block diagram of an example system 200 for implementing virtual reality applications. The system 200 includes an application 220 that creates a virtual environment based on records 210a-210n (210 in general) for N different users. The records 210 are based on information collected and stored by ticket carriers 115 used by the different users. As mentioned above with reference to FIG. 1, the records store information on the corresponding users' interactions with different access points 105.

The records for the different users are provided to a central repository such as the server 120. The application 220 communicates with the server 120 to create a virtual environment 130 which is based, at least in part, on the information from the plurality of records. For example, if the application 220 creates a virtual environment 130 that represents a particular train that in reality traveled from station A to station B between 10:00 AM and 11:00 AM in the morning, the user records 210 can be used to determine a set of users who were traveling on that train. If the application is a multiplayer game, virtual characters 125a-125n (125 in general) corresponding to the determined set of users can be positioned accordingly in the train.

In some implementations, the server 120 may also access some pre-stored information 225 for the application 220 to create the virtual environment 130. For example, the pre-stored information can include maps 230, or schedules 235 related to the public transport network that the application 220 creates as part of the virtual environment 130. For example, if a user record 210 indicates that a user accessed and rode the subway between 10:00 AM and 11:00 AM in the morning to go from station A to station B, the pre-stored information 225 can help determine which train or trains the user could have taken for the journey. The positioning of the corresponding virtual character can be determined accordingly. The pre-stored information 225 can be stored in the server 120 or in a storage device external to the server 120.

The virtual environment 130 has been described above with the example of a subway system. However, other virtual environments are also within the scope of the present disclosure. For example, the virtual environment 130 can be a highway system, the occupants of which are tracked using a RFID toll system. In one application of such a virtual environment, the users can race against each other in a multiplayer virtual reality game. The location information, as tracked using the RFID system, can be used to determine where a user enters and/or exits the highway system. In such an implementation, the virtual character corresponding to the user can be a car or other vehicles that the user can control in the virtual environment 130. Similarly, the virtual environment 130 can be based on other real-world environments where location information of the user can be tracked using a suitable ticket carrier.

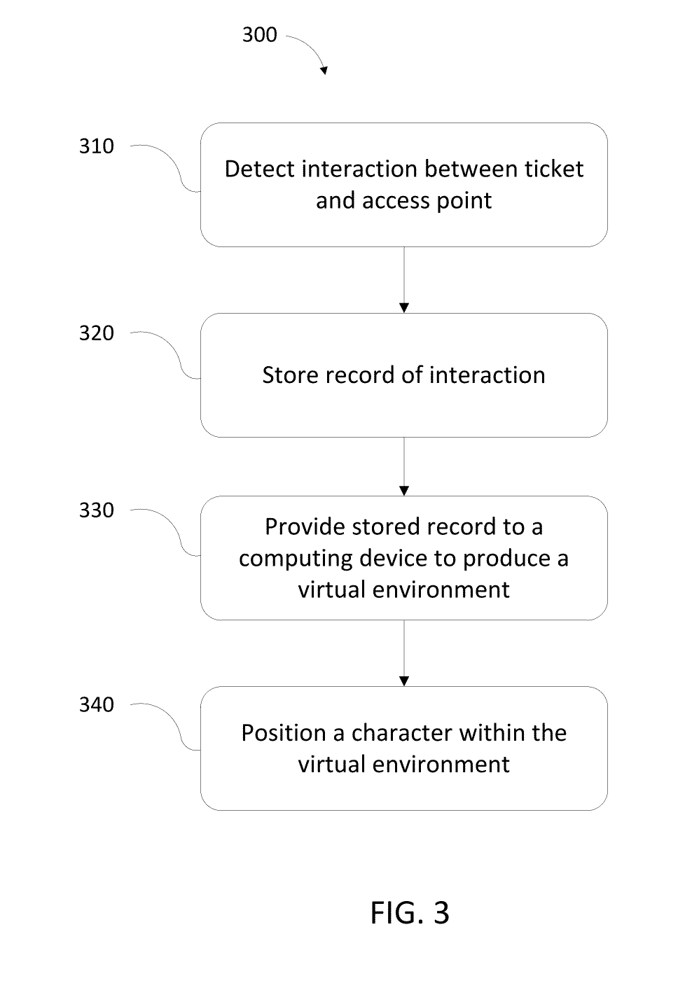

FIG. 3 is a flowchart 300 of an example of a sequence of operations for implementing a virtual reality application. The operations can be performed by any combination of the ticket carrier 115, server 120, client device 140 or other computing devices. Operation can include detecting (310) an interaction between a ticket 110 and an access point 105. The interaction can be detected by a ticket carrier that holds the ticket or is positioned in proximity to the ticket 110. The detection can be done using a technology or mechanism substantially similar to the technology or mechanism used for the interaction between the ticket 110 and a reader at the access point 105. For example, if the ticket 110 and the reader at the access point 105 interact using NFC, the ticket carrier 115 can be equipped with another NFC chip that separately detects the interaction. In some implementations, the technology or mechanism that is used for the detection is substantially different from the technology or mechanism used for the interaction between the ticket 110 and the reader. For example, the ticket and the reader can interact using NFC whereas a magnetometer is used in the ticket carrier for detecting the interaction. In some cases, a different frequency or polarization of signal may also be used.

Operations also include storing (320) a record of the interaction. Storing the record can include storing one or more of a time of the interaction and a location of the interaction along with an identification of the ticket 110 such that the interaction can be linked to the particular user. The storing is usually done on a storage device (such as magnetic memory) located on the ticket carrier 115. In some implementations, the records can be stored in memory locations external to the ticket carrier 115.

Operations can also include providing (330) the stored records to a computing device to produce a virtual environment. Executed operations on the computing device can produce the virtual environment that partially represents a public transportation system. In some implementations, the stored records can be provided from a server (e.g. server 120) that receives the records from one or more ticket carriers 115. In some implementations, the stored records can be provided to the computing device that creates the virtual environment directly from a ticket carrier 115. The stored records can be provided to the computing device from the ticket carrier 115 through one or more intermediate devices including, for example a server, a kiosk, or a storage device that stores the records temporarily.

Operations also include determining (340) a location for positioning a virtual character within the virtual environment. The virtual character is generally linked to a user of the corresponding ticket carrier that detects the interactions between the ticket 110 and the access point 105. In some implementations, where there are multiple records corresponding to different users, locations for positioning multiple virtual characters may be determined. In such cases, each virtual character is generally linked to one particular user. The virtual character can represent a live being such as a human, or animal or can represent an inanimate object such as a car or a robot. The determined location can be manipulated or changed, at least within certain limits, by the user based on input received from a computing device. For example, if a user plays a game that creates the virtual environment and the determined location is used to position a corresponding virtual character within a portion of the virtual environment (a railway carriage, for example), the user can manipulate the position of the character within the carriage by providing inputs through the computing device used for playing the game. Such manipulation may be needed, for example to achieve the objectives of the game.

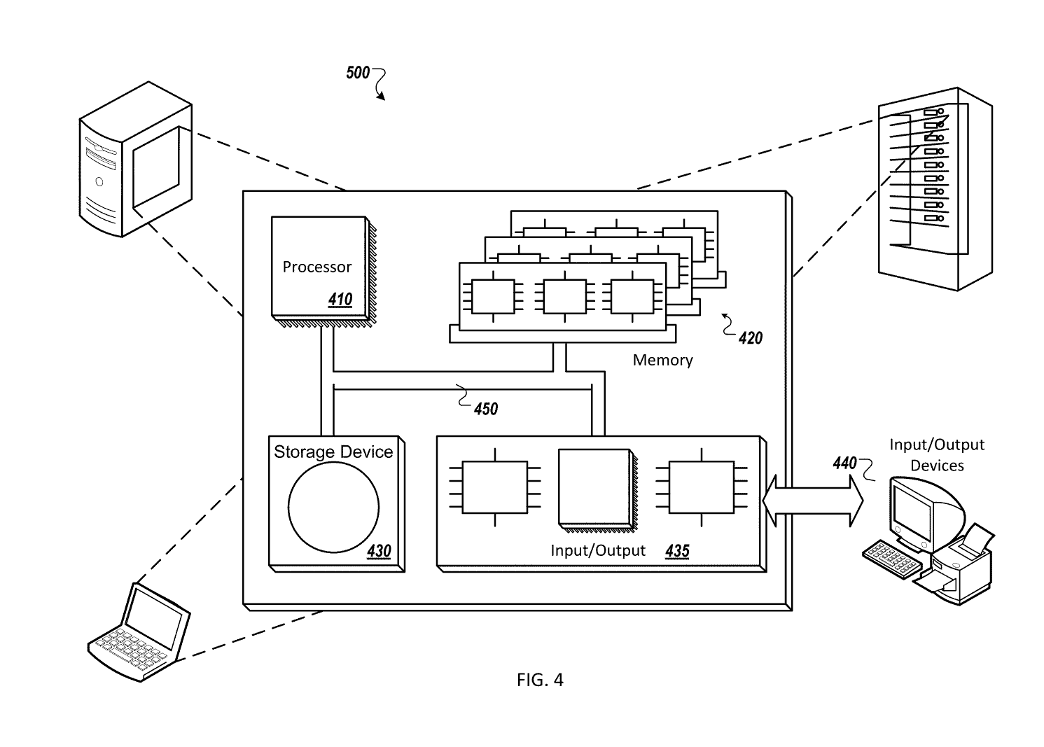

FIG. 4 is block diagram of an example computer system 400 that can be used to provide keyword suggestions. The system 400 includes a processor 410, a memory 420, a storage device 430, and an input/output device 440. Each of the components 410, 420, 430, and 440 can be interconnected, for example, using a system bus 460. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 460.

The web server, advertisement server, and impression allocator can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

This written description sets forth the best mode and provides examples to enable a person of ordinary skill in the art to make and use the methods and systems described herein. This written description however does not limit the scope of the disclosure to the precise terms set forth. Thus, other implementations along with alterations, modifications and variations to the examples are within the scope of the following claims:

1. A method comprising:
detecting, by circuitry included in a ticket carrier for carrying a public transportation system access ticket, an interaction between the ticket and an access point of the public transportation system at a first time point, wherein the ticket carrier is an object or device separate from the ticket and the access point;
storing, on a storage device, a record of the interaction; and
providing to a computing device, the stored record at a second time point different from the first time point, wherein executed operations of the computing device produce a virtual environment that partially represents the public transportation system and position a character within the virtual environment based upon the stored record.

2. The method of claim 1, wherein detecting the interaction is based at least on a communication between the access point and a near-field communication (NFC) chip included in the circuitry.

3. The method of claim 1, wherein detecting the interaction is based at least on a communication between the access point and a radio frequency identification (RFID) tag included in the circuitry.

4. The method of claim 1, wherein the storage device is provided on the ticket carrier.

5. The method of claim 1, wherein the virtual environment includes at least one other character positioned at another location based on another stored record that represents another detected interaction.

6. The method of claim 1, wherein storing the record of the interaction includes storing data that represents a time and place of the interaction.

7. The method of claim 1, wherein providing the stored record to the computing device includes providing the stored record to a mobile device from the ticket carrier.

8. A system comprising:
a ticket carrier configured to receive a public transportation system access ticket, the ticket carrier comprising circuitry to detect and store an interaction between the ticket and an access point of the public transportation system at a first time point, wherein the ticket carrier is an object or device separate from the ticket and the access point; and
a computing device configured to receive a record of the interaction from the ticket carrier at a second time point different from the first time point, wherein executed operations of the computing device produce a virtual environment partially representing the public transportation system and position a character within the virtual environment based upon the record.

9. The system of claim 8, wherein the circuitry of the ticket carrier includes a near-field communication (NFC) chip.

10. The system of claim 8, wherein the circuitry in the ticket carrier includes a radio frequency identification (RFID) tag.

11. The system of claim 8, wherein the ticket carrier further includes a transmitter to transmit the record of the interaction.

12. The system of claim 8, wherein the computing device is a mobile phone.

13. The system of claim 8, wherein the computing device is configured to receive the record of the interaction from a mobile phone.

14. The system of claim 8 further comprising a client device on which the virtual environment is rendered.

15. The system of claim 14, wherein the position and actions of the character within the virtual environment can be controlled using the client device.

16. A non-transitory computer readable storage device having encoded thereon computer readable instructions, which when executed by a processor, cause the processor to perform operations comprising:
receiving from a ticket carrier, a record of an interaction between a public transportation system access ticket and an access point of the public transportation system, wherein the ticket carrier is configured to receive the ticket and detect and store the interaction and wherein the ticket carrier is an object or device separate from the ticket and the access point;
creating a virtual environment that partially represents the public transportation system;
positioning a character within the virtual environment based on the received record;
receiving user-input representing an action of the character; and
rendering the action of the character in the virtual environment based on the received instructions.

17. The computer readable storage device of claim 16, further comprising instructions to receive the user-input from a client device.

18. The computer readable storage device of claim 17, wherein the computer readable instructions are executed on the client device.

19. The computer readable storage device of claim 16 further comprising instructions to position at least one other character within the virtual environment based on another received record that represents another interaction.

20. The computer readable storage device of claim 16 wherein the record of the interaction is received from the ticket carrier through at least one intervening computing device.
